(19) United States
(12) Patent Application Publication
(10) Pub. No.: US 2025/0162711 A1
(43) Pub. Date: May 22, 2025

(54) Versatile UAV with Robotic Arm for Autonomous and Manual Operation

(71) Applicant: Nick Reyntjens, Bansko (BG)

(72) Inventor: Nick Reyntjens, Bansko (BG)

(21) Appl. No.: 18/927,877

(22) Filed: Oct. 26, 2024

Related U.S. Application Data
(60) Provisional application No. 63/546,033, filed on Oct. 27, 2023.

(51) Int. Cl. B64D 1/18; A01M 7/00; B25J 9/10; B25J 13/00; B25J 15/00; B64D 47/06

(52) U.S. Cl. CPC B64D 1/18; A01M 7/0032; B25J 9/104; B25J 13/006; B25J 15/0019; B64D 47/06

(57) ABSTRACT

A UAV is disclosed, comprising a robotic arm having an upper arm portion and a lower arm portion configured to articulate relative to each other in a vertical plane. The articulation is remotely actuated, enabling controlled movement of the robotic arm for various tasks. The UAV may further include features such as an antagonistic actuation mechanism, additional actuators for horizontal movement, an end effector for interacting with objects, a camera for detecting targets, and a control system for autonomous operation. A system for autonomous operation may include a station for battery swapping or recharging. Methods of commercially exploiting the UAV, robotic arm, or associated build kits and instructions are also disclosed. The invention is particularly suited for applications where budget-friendly construction is desired, such as in the toy industry, or where many instances of the invention are needed to perform the possible work, such as pest control in agricultural settings. A mechanism for decoupling components from the UAV body's rotation reduces the moment forces that propellers need to overcome for roll and pitch adjustments, allowing for smaller motors and a lighter, safer, and cheaper design.

### CROSS-REFERENCE TO RELATED APPLICATION

This application claims priority to the following provisional patent applications:
U.S. Provisional Application No. 63/546,033, filed on Oct. 27, 2023, entitled “Autonomously moving apparatus for killing agricultural insect pests.”
Portugal Application No. 20232005591675, filed on Nov. 19, 2023, entitled “Autonomously moving apparatus for killing agricultural insect pests.”
Portugal Application No. 20242005789291, filed on Jan. 24, 2024, entitled “Autonomously moving apparatus for killing agricultural insect pests.”
Portugal Application No. 20242006085371, filed on May 3, 2024, entitled “Autonomously moving apparatus for killing agricultural insect pests.”
Portugal Application No. 20242006315093, filed on Jul. 19, 2024, entitled “AUTONOMOUS APPARATUS FOR MAINLY LASER-BASED NEUTRALIZATION OF AGRICULTURAL PESTS”
Portugal Application No. 20242006334293, filed on Jul. 25, 2024, entitled “AUTONOMOUS APPARATUS FOR MAINLY LASER-BASED NEUTRALIZATION OF AGRICULTURAL PESTS”
Portugal Application No. 20242006416607, filed on Aug. 25, 2024, entitled “AUTONOMOUS APPARATUS FOR MAINLY LASER-BASED NEUTRALIZATION OF AGRICULTURAL PESTS”
Portugal Application No. 20242006449796, filed on Sep. 5, 2024, entitled “Autonomously moving apparatus for killing agricultural insect pests”

### TECHNICAL FIELD

This invention relates to unmanned aerial vehicles (UAVs), and more particularly to UAVs equipped with robotic arms for manipulation tasks, and methods of commercially exploiting such UAVs. The invention is particularly suited for applications where budget-friendly construction is desired, such as in the toy industry, or where many instances of the invention are needed to perform the possible work, such as pest control in agricultural settings.

### SUMMARY

The present invention provides a UAV with a robotic arm that offers improved dexterity and stability for performing manipulation tasks. The robotic arm is designed to articulate in a vertical plane, allowing for precise control of its movement. This enables the UAV to perform a variety of tasks, such as interacting with objects, collecting samples, and performing maintenance.

The invention further includes features to enhance stability and control, such as an antagonistic actuation mechanism, additional actuators for horizontal movement, and a mechanism for decoupling components from the UAV body's rotation. This decoupling mechanism reduces the moment forces that the UAV's propellers need to overcome to achieve desired roll and pitch angles. This allows for the use of smaller, less powerful motors, which in turn makes the UAV smaller, lighter, safer, and cheaper to produce.

The UAV may also be equipped with a camera and a control system for autonomous operation, and a system for autonomous operation may include a station for battery swapping or recharging.

Furthermore, the invention covers methods of commercially exploiting the UAV, robotic arm, or associated build kits and instructions, including advertising, offering repair and maintenance services, hosting and displaying advertisement material, using the UAV in commercial activities, and providing building instructions. This protects the intellectual property and commercial value of the invention.

The use of lightweight and readily available materials, such as foam board or 3D-printed components, makes the invention suitable for budget-friendly construction, opening up possibilities for applications in the toy industry, where affordability is a key consideration. The low cost and ease of production also make the invention ideal for applications where a large number of units are required, such as in agricultural settings for tasks like targeted pest control.

The UAV with robotic arm according to the present invention is not only suitable for practical applications such as pest control or maintenance tasks, but also offers potential in the field of entertainment. By equipping the robotic arm with a light source or a spraying mechanism, various entertainment applications can be realized. For example, the UAV could be used for aerial light painting, creating dynamic and interactive light shows, or for generating special effects like confetti or bubble releases. The robotic arm's dexterity and precision also enable the UAV to be used for interactive games, artistic performances, or even aerial puppetry. This versatility expands the commercial potential of the invention and demonstrates its adaptability to various creative and entertaining applications.

Further, the arm may also facilitate fruit and nut picking, and painting, and pollinating operations.

### DETAILED DESCRIPTION OF THE EMBODIMENT

Referring to the accompanying drawings, an embodiment of the present invention is illustrated and described in detail below.

### BRIEF DESCRIPTION OF THE DRAWINGS

FIG. 1 shows the robotic arm

FIG. 2 shows the robotic arm

FIG. 3 shows the robotic arm mounted on a uav, with a component hanging from uav that aids the functional operation, in this example a high voltage module that makes high voltage suitable for electrocuting target insects.

FIG. 4 shows the detailed operation of the 3 servos that manipulate the arm in optionally 3 degrees of freedom.

FIG. 5A shows the E and D movements of the arm.

FIG. 5 shows the E and D movements of the arm.

FIG. 6A shows the F movement of the arm.

FIG. 6B shows the F movement of the arm.

FIG. 7 shows the robotic arm being used to kill pest insects (12), and how to AI selectively kills or lets live insects of different species or having different features.

FIG. 8 shows end effector 122B

FIG. 9 shows end effector 122C

FIG. 10 shows end effector 122D

FIG. 11 shows end effector 122E

FIG. 12 exemplifies that the arm may also have an entertainment function, suitable as a toy, or in visual storytelling, or part as in a show, or movie.

FIG. 13 shows a reservoir containing paint (128C) suspended below the UAV frame.

FIG. 14 shows the UAV equipped with a robotic arm for manipulating a vacuum cleaning end effector (122M).

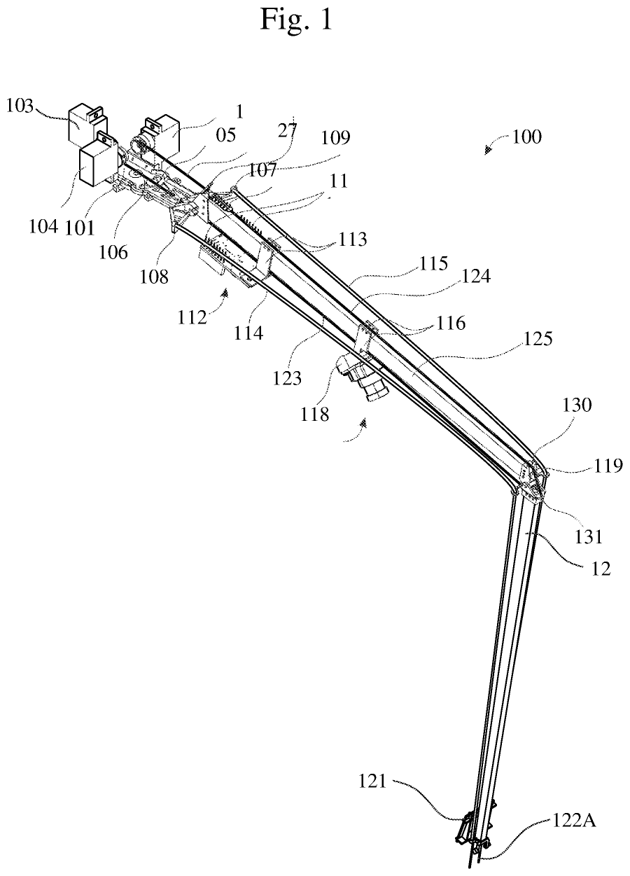

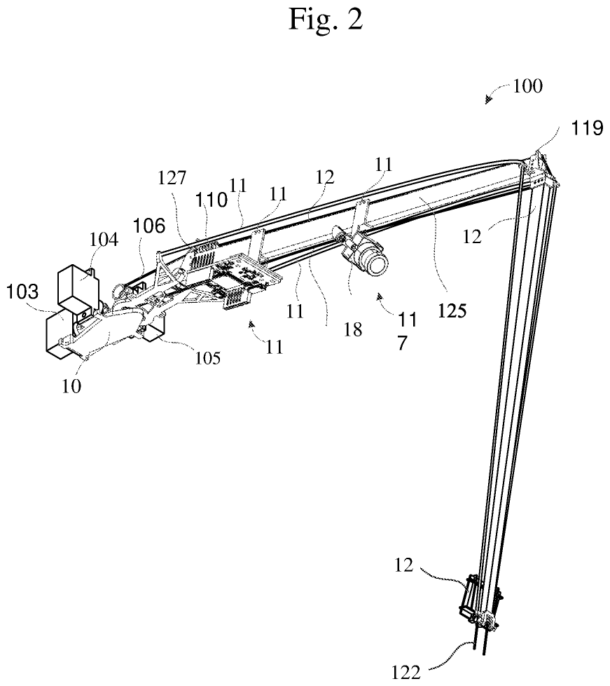

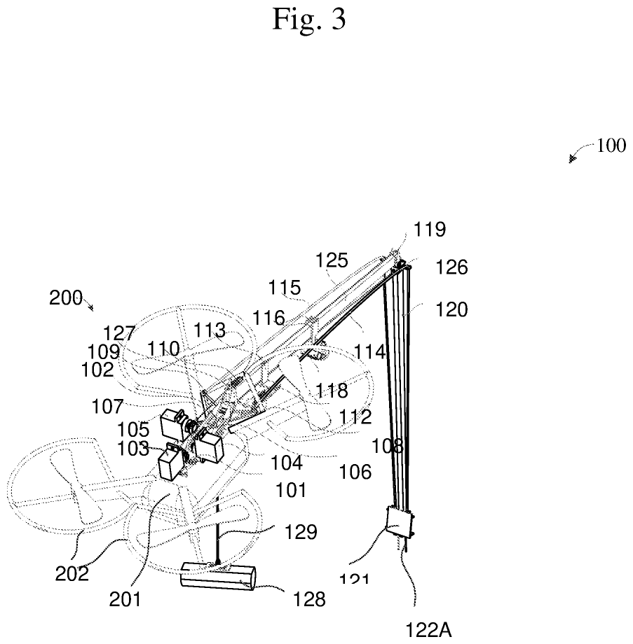

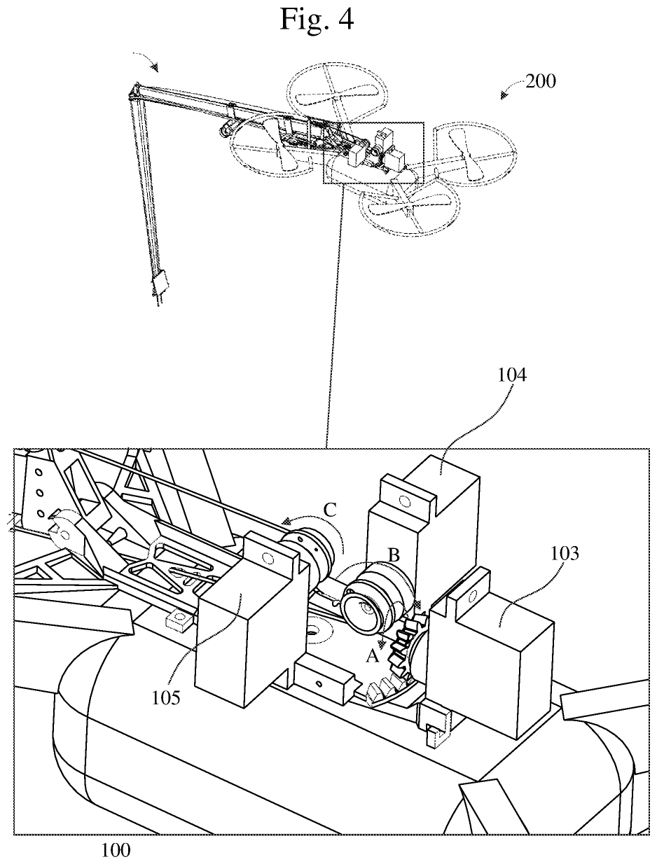

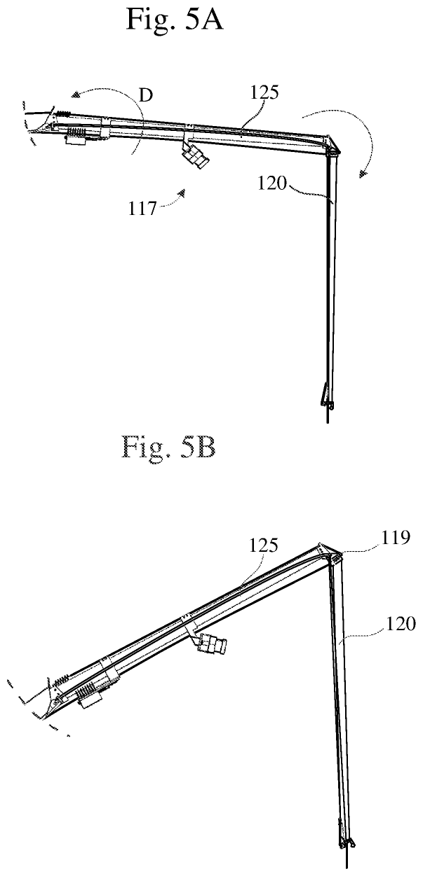

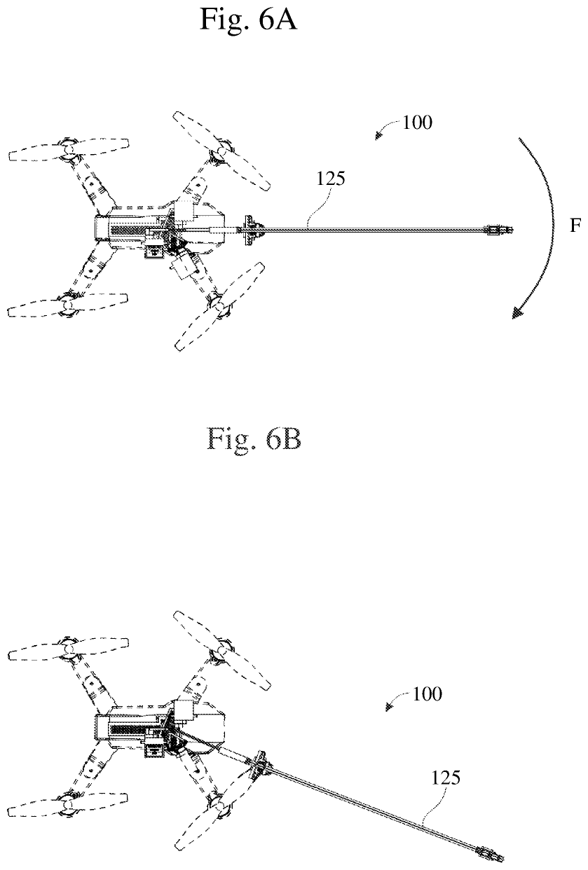

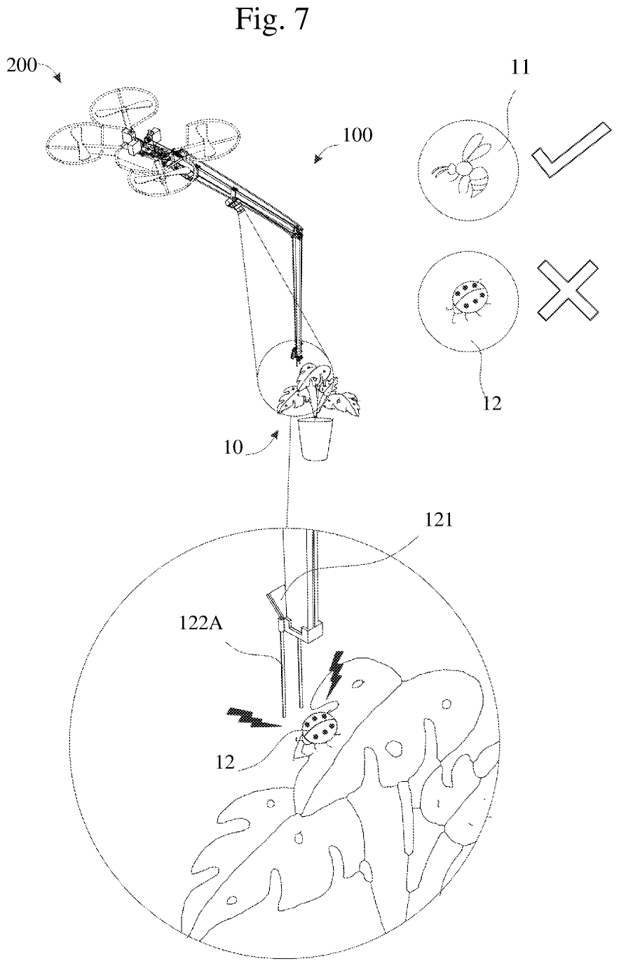

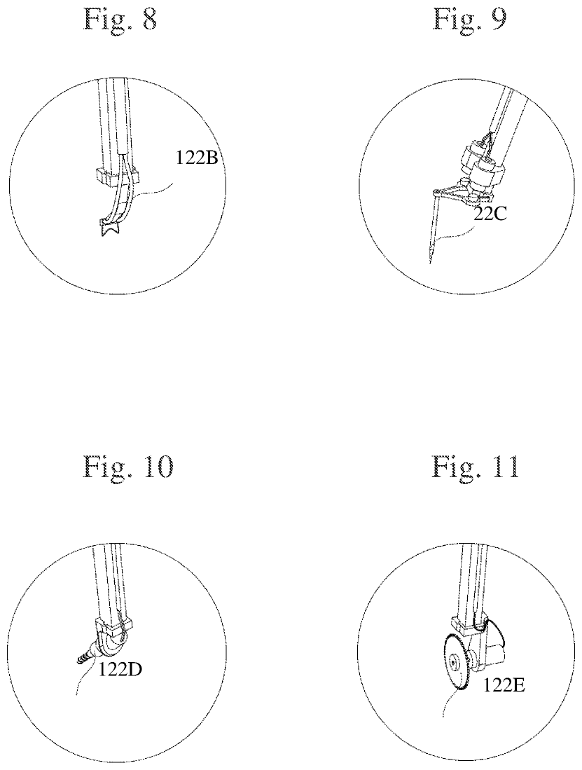

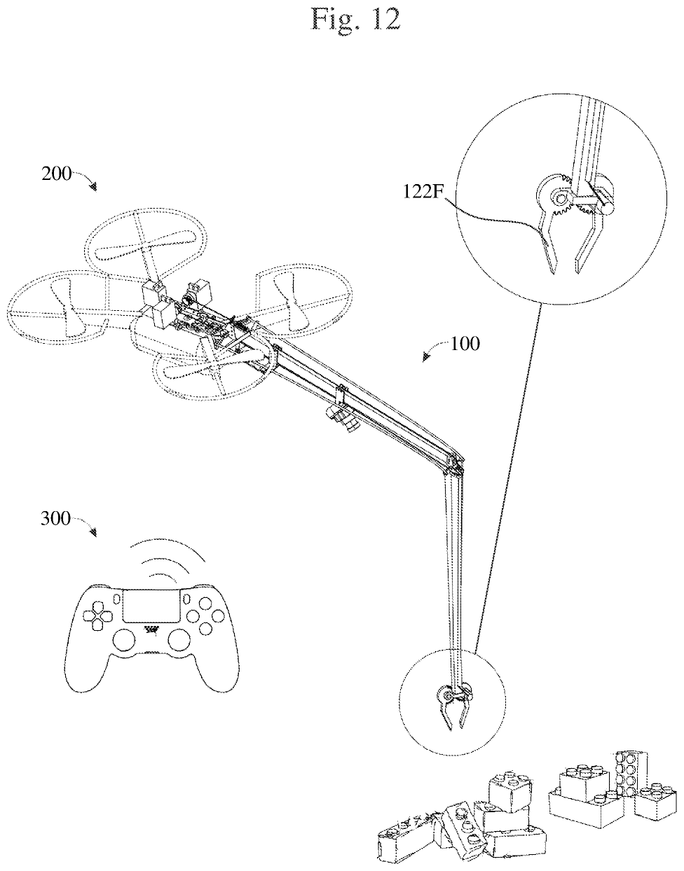

### DETAILED DESCRIPTION

Specific features, structures, or characteristics mentioned in reference to a particular embodiment may or may not be present in other embodiments. The use of terms such as “one embodiment,” “an embodiment,” or “an illustrative embodiment” does not imply limitations or exclusivity. Additionally, references to “preferred” components or features signify their desirability in specific contexts but do not restrict their applicability to other embodiments.

It is understood that a person skilled in the art, upon reviewing this disclosure, can readily implement described features, structures, or characteristics in connection with other embodiments, whether explicitly described or not.

Listings in the form of “at least one of A, B, and C” encompass all possible combinations of A, B, and C, including individual elements and their conjunctions. The same principle applies to listings in the form of “at least one of A, B, or C” and “A, B, and/or C.” In the claims, terms like “a,” “an,” “at least one,” and “at least one portion” are not limiting to a single element unless explicitly stated.

While the drawings illustrate specific arrangements and orderings of structural or method features, these are not prescriptive. In various embodiments, such features may be arranged differently or combined, unless otherwise specified. The inclusion of a feature in a particular figure does not imply its necessity in all embodiments.

The disclosed embodiments can be implemented in hardware, firmware, software, or any combination thereof. They can also be embodied as instructions stored on machine-readable media, executed by one or more processors.

The unmanned aerial vehicle (UAV) 200 may comprise a main body, or fuselage, typically housing the flight controller, primary battery, and communication systems (not shown). Attached to this body may be a robotic arm 100, designed for manipulation tasks. The robotic arm 100 may consist of an upper arm linkage 125 and a lower arm linkage 120 connected by a hinge 119. This hinge 119 may allow the arm to articulate in a vertical plane (movement E), enabling a wide range of motion.

The articulation of the robotic arm 100 may be remotely actuated through a series of cables and actuators. The primary hinge 119 may be actuated by a first actuator 104 via a hinge actuation cable 123. This cable 123 may be attached to the hinge 119 at an attachment point 126 and may extend to the first actuator 104, which may be a servo motor. The antagonistic force required for controlled movement of the hinge 119 may be provided by a second cable 124, referred to as the hinge antagonistic force cable. This cable 124 may be attached to the hinge 119 at an attachment point 131 and guide via a cable guide feature 139 and may be connected to a spring 110, rubber band, or other flexible element to provide the opposing force.

The upper arm linkage 125 may be further capable of angular positioning in a vertical plane relative to the UAV body through a second actuator 105 and an upper limb raise cable 107, enabling movement D. This cable 107 may be attached to the upper arm linkage 125 at an attachment point 127 and may extend to the second actuator 105, which may also be a servo motor. The servo motors may utilize pulleys to modify the force or direction of the actuation cables.

Additionally, a third actuator 103 may be responsible for controlling the rotation of the robotic arm 100 relative to the UAV body, movement F. This could allow the arm to be positioned in various orientations for increased flexibility in manipulation tasks.

A base plate 101 may have a hinge that connects to element 102, to which the two servos 104 and 105 are secured, and enables rotation of element 102 in a horizontal plane via servo 103.

In some embodiments, the robotic arm 100 may be constructed as a single, integrated piece with a living hinge incorporated therein. This living hinge may be formed by a flexible section or joint within the arm structure, allowing for articulation between the upper and lower portions of the arm. The living hinge may provide inherent antagonistic actuation, where the flexibility of the material itself acts as a spring, returning the arm to a neutral position after actuation. A cable and actuator system may be used to bend the arm at the living hinge, enabling controlled movement in a vertical plane. This design could offer advantages in terms of simplicity, reduced part count, and potentially lower weight.

In a preferred embodiment, the robotic arm is configured such that the end effector may be positioned outside of the propeller wake generated by the UAV's propellers during manipulation tasks. This positioning may be achieved by orienting the upper arm portion predominantly in a horizontal plane relative to the UAV body. By minimizing the influence of the propeller wake on the end effector, manipulation tasks may be performed with increased stability and precision. This configuration may be particularly beneficial for delicate or precise tasks where the end effector needs to interact with objects or the environment without being disturbed by the turbulent airflow from the propellers. Such turbulence could otherwise cause undesirable shaking or movement of the target object, for instance, an insect resting on a leaf, making precise manipulation more difficult.

This invention discloses a robotic apparatus that may be used, among other applications, for the automated extermination of insect pests. The apparatus may comprise a vision system with at least one high-resolution camera 118 that can be associated with advanced image recognition software. This software may be trained to identify pre-defined insect pests based on visual characteristics such as shape, size, and color patterns. Upon identification of a target pest within the camera's field of view, the vision system may generate positional data corresponding to the spatial coordinates of said pest. This data could be relayed to a control unit 111, which could utilize a pathfinding algorithm to dynamically determine the most efficient route for an attached robotic arm to reach the target pest. The robotic arm, comprising a plurality of joints providing at least one degree of freedom, may receive and execute movement commands from the control unit. Attached to the robotic arm may be an end effector 122A equipped with electrodes. Upon reaching the intercept position, as determined by the control unit, the end effector may deliver a high-voltage, low-amperage electrical charge to neutralize the target pest. Crucially, the present invention can operate within a continuous feedback loop. The vision system may continuously monitor the position of both the target pest and the end effector, feeding this real-time positional data back to the control unit. This could allow for dynamic adjustment of the robotic arm's trajectory to ensure precise targeting and maintain optimal end effector positioning throughout the extermination process, maximizing efficacy and minimizing collateral damage.

In some embodiments, the lower arm linkage 120 may be oriented to point upwards. This configuration is advantageous when the UAV 200 primarily operates below its work area, such as when pollinating kiwi plants grown on trellises. Alternatively, the upper arm linkage 125 may be oriented predominantly vertically, enabling the lower arm linkage 120 and end effector to extend downwards or upwards from the UAV. This allows for manipulation of objects both below and above the UAV, enhancing its versatility for tasks such as inspecting infrastructure or interacting with a wider range of targets. To achieve these orientations, the hinge joint 119 may be modified for increased range of motion, by placing the hinge rotation point centrally instead of on top or bottom side of the hinge, the actuator control may be adjusted, and a suitable end effector may be selected. This adaptability enhances the versatility of the robotic arm for various manipulation tasks.

The lower arm linkage 120 may terminate in an end effector, which is the part of the robotic arm that may interact with the environment. The end effector could be configured for various tasks, such as grasping objects, spraying liquids, or manipulating tools. A range of interchangeable end effectors may be provided, each designed for a specific function. These may include:
122A: Electrode: For delivering a high-voltage electrical charge to neutralize insect pests.
122B: Hot Wire: For thermally ablating or cauterizing target objects.
122C: Actuated Piercing Needle: For puncturing or injecting substances into targets.
122D: Actuated Drill: For creating holes or extracting samples, or killing insects.
122E: Actuated Circular Saw: For cutting or severing objects, or killing insects.
122F: Gripping end effector: for lifting and depositing object
122G: Nozzle/Liquid Dispensing Opening: For precise application of liquids, such as marking agents, paint, pesticides, or other treatments. This nozzle may be connected to a liquid dispensing system as described later in this document.
122H: Pollination Brush: A small brush with soft bristles, configured to gently collect and transfer pollen from flowers, such as those on apple trees or other crops, for targeted pollination. This end effector may be designed to optimize pollen collection and deposition, potentially incorporating features like vibration or electrostatic charging to enhance pollination efficiency.
122I: Inspection camera: A camera can be used as end effector, this allows the inspection of hard to reach places.
122J: Fruit picker: A fruit picking end effector can be used, to for example pick cherries.
122k: Cleaning end effector: A sponge or brush end effector can be used, optionally with a liquid container hanging from the drone, to enable cleaning operations.
122M: Vacuum cleaning end effector: a suction hole, possibly with bristles, connection to air hose.

The versatility of this system is further enhanced by the ability to easily swap out end effectors. A scissor end effector for precise removal of plant matter, an electrostatic gripping end effector for delicate fruit handling, and others can be readily integrated. Furthermore, an end effector designed to direct a targeted burst of air towards a flower—either to trigger pollen release or to deliver pollen-laden air, or to enable self pollination—could be easily incorporated. The robotic arm's precise 3D positioning capabilities enable highly accurate and delicate operations within the plant canopy.

The UAV 200 may also be equipped with a camera 118 for visual sensing and target identification. The camera 118 may be positioned to provide a clear view of the workspace of the robotic arm 100. In some embodiments, a mirror 121 may be used to enhance the camera's field of view or provide different perspectives. Also a stereo vision camera may be added.

The UAV 200 may be controlled remotely by a human operator using a remote control 300. The remote control 300 may send signals to the actuators 104, 105, 103 to control the movement of the robotic arm 100 and the orientation of the end effector. This can be done by adding a rc receiver and coupling it to the actuators.

Power for the UAV 200 and its robotic arm 100 may be provided by a battery. In some embodiments, a high voltage module 128 may be used to provide the necessary voltage for the electrodes 122A. To enhance stability, the high voltage module may be suspended from the UAV body using a rope 129 or other flexible mechanism, decoupling its mass from the UAV's rotational movement. In a similar way a basket or liquid container may hang from the uav's body, of the application requires it.

In some embodiments the arm may also be decoupled from the UAV's rotational movement, for example by a 2 or 3 axis gimbal. This would allow the end effector to hold a more stable position while manipulating. The central portion of the arm holding the actuators may be positioned above or below the uav body.

In some embodiments, the UAV may incorporate computer vision and AI for automated target identification and neutralization. A camera mounted on the UAV could capture images, which may be processed by an onboard or remote processing unit to identify potential insect targets using computer vision algorithms. AI-based classification models could then differentiate between insect species based on visual characteristics, potentially enabling the system to distinguish between beneficial insects and harmful pests. This classification data could inform a control system, which may determine the appropriate action based on predefined parameters, including target species and risk assessments. If an identified insect is deemed a threat, the control system could direct the robotic arm and appropriate end effector to its location for neutralization. This automated system may increase efficiency and precision by minimizing manual intervention and ensuring that only harmful insects are targeted, potentially promoting ecological balance. This embodiment highlights the versatility of the invention for various pest control applications.

In embodiments of the present disclosure, an autonomous aerial vehicle may be configured to monitor and dynamically adjust estimated insect emergence rates based on real-time observations. During operation, the aerial vehicle may traverse a designated area and employ onboard sensors, such as a camera, to detect and count target insects. This data may be associated with specific locations within the area using location tracking mechanisms, such as GPS coordinates or predefined geofences. Upon completion of a survey of a location, or at predetermined intervals, the aerial vehicle may then recalculate the estimated insect emergence rate for that location based on the observed insect count and the time elapsed since the previous observation. This updated rate may be used to refine the vehicle's hunting strategy, potentially improving its efficiency and effectiveness in eliminating target insects.

Furthermore, the aerial vehicle may employ a location prioritization algorithm to determine which locations to visit next. This algorithm may consider various factors, such as the estimated insect emergence rate, environmental factors conducive to insect presence, and the time elapsed since the last visit to each location. The algorithm may also incorporate a confidence measure that dynamically balances the influence of these factors based on the amount and recency of data available for each location. By prioritizing locations with a higher likelihood of insect presence and adjusting the strategy based on real-time observations, the aerial vehicle can efficiently and effectively target areas requiring pest control intervention.

The algorithm may iterate through each location, calculating the time elapsed since its last visit. If no prior estimate exists, the beetle rate may be estimated using neighboring data or a default value. An estimated beetle count may then be calculated by multiplying the estimated beetle rate by the time since the last visit. The algorithm may then calculate a weighted confidence measure, combining various factors like visit count and time since last visit, using logarithmic, sigmoid, and exponential decay functions. These confidence measures may be used to dynamically adjust the weights assigned to the estimated beetle count and environmental factors when determining a priority value for each location. Finally, the algorithm may sort the locations by priority and select the top-ranked locations, potentially including a randomly chosen location to encourage exploration.

The robotic arm 100 could be constructed from various lightweight materials, such as foam board, foamed plastic, polystyrene, or 3D-printed expanded filament. The use of these materials may help to minimize the weight of the arm, which could be crucial for maintaining the UAV's flight performance.

A spray mechanism for liquid delivery may be mounted to the robotic arm as an end effector. This mechanism could be fed liquid from a pump, via a tube, such as a micro-diaphragm or piezoelectric pump. Said pump may be integrated into a liquid reservoir, potentially attached via a mechanism that isolates the reservoir from rotational movement of the UAV body about at least one of a roll axis and a pitch axis, thereby minimizing the impact of the reservoir's weight on the UAV's stability and maneuverability.

This tube may route the liquid along the arm, potentially within internal channels for protection and a streamlined profile, to an atomizing nozzle fitted to the end effector. To further enhance performance, a valve, such as a lightweight pinch valve or a needle valve, may be incorporated at the nozzle end effector, located at the end of the lower arm linkage.

This valve may be actuated remotely via a cable, or possibly Bowden cable and a suitable remote actuator, allowing for rapid control of liquid flow and minimized response times. This configuration reduces lag between pump activation and dispensing, preventing unwanted dripping or leakage.

Additionally, a small reservoir, potentially formed by a thickened section of the liquid delivery tube just prior to the valve, could be included to ensure instant pressure availability at the nozzle, leading to consistent and efficient atomization of the liquid for precise and controlled application. The small reservoir at the end allows for the use of a very thin supply tube, minimizing weight and complexity. The nozzle, selected for its precision and ability to generate the desired droplet size, could be a pressure-swirl atomizer or another suitable type. The pump operation may be electronically controlled and integrated with the robotic arm's control system, enabling coordinated movement and precise timing of liquid dispensing.

Optional sensors, such as flow or pressure sensors, may be included for monitoring and regulation of the spray. The entire mechanism may be carefully mounted and balanced to ensure optimal weight distribution and UAV stability during operation. This system could allow for precise targeting, controlled dosage, and efficient application of liquids for plant marking, micro-pesticide application, or other tasks requiring precision liquid delivery.

In some embodiments, a second remotely actuated hinge may be incorporated into the robotic arm 100. This second hinge articulates a third arm linkage, providing an additional degree of freedom and enabling more complex movements. This configuration allows for greater dexterity and reach, particularly useful for tasks requiring precise positioning of the end effector, such as pollination.

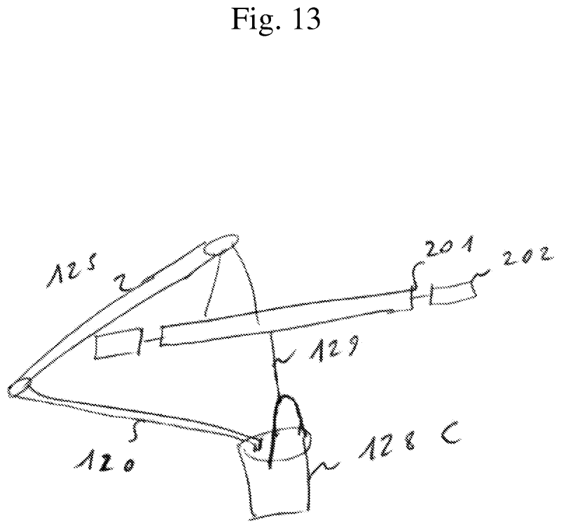

Alternatively, in one embodiment, a method for painting a structure with an unmanned aerial vehicle (201) is provided, and this method may comprise providing a UAV having a frame, a robotic arm coupled to the frame, and at least one rotor providing lift to the UAV, wherein the robotic arm may have one or more hinges. The method may further comprise suspending a reservoir containing paint (128C) below the UAV frame, wherein the reservoir may be suspended by a rope (129), and affixing a painting implement to an end effector of the robotic arm, wherein the painting implement may comprise a roller, a brush, or a sprayer, and may be attached to the arm using a quick-release coupling mechanism or a screw-on attachment. The UAV may be maneuvered to a position proximate the structure, and the robotic arm may be manipulated via the one or more hinges to position the painting implement below the UAV frame and dipping the painting implement into the reservoir. The method may also comprise manipulating the robotic arm via the one or more hinges to position the painting implement against the structure to apply paint. A volume of paint in the reservoir may be monitored using a sensor that measures the weight of the reservoir or an optical sensor that detects the paint level, and upon determining that the volume of paint is below a predetermined threshold, the UAV may be autonomously maneuvered to a refill station to replenish the reservoir. At the refill station, the UAV may dock with the station using a guided docking system and replenish the reservoir using a pump or a gravity-fed mechanism to transfer paint from the station to the reservoir. FIG. 13 illustrates this embodiment.

In one embodiment, a method for harvesting fruit or nuts with an unmanned aerial vehicle (UAV) may comprise providing a UAV having a frame, a robotic arm coupled to the frame, and at least one rotor providing lift to the UAV, wherein the robotic arm may have one or more hinges; suspending a basket for collecting fruit or nuts below the UAV frame, wherein the basket may be suspended by a rope; affixing a grasping implement to an end effector of the robotic arm, wherein the grasping implement may comprise a two-finger closing mechanism like a gripper or a suction cup, or a combination thereof configured to grasp and hold the fruit or nuts without damaging them; maneuvering the UAV to a position proximate a fruit- or nut-bearing tree or plant; manipulating the robotic arm via the one or more hinges to position the grasping implement to pick fruit or nuts; manipulating the robotic arm via the one or more hinges to position the grasping implement above the basket and releasing the fruit or nuts into the basket; monitoring a volume of fruit or nuts in the basket using a weight sensor or an image recognition system, and upon determining that the volume is above a threshold, autonomously maneuvering the UAV to a collection point; and at the collection point, actuating a mechanism to open the basket and discharge the fruit or nuts, for example, by pulling a rope coupled to a trap door or a drawstring release mechanism on the basket with an actuator. FIG. 13 illustrates this embodiment.

The design of the robotic arm enables tasks to be executed with the help of suitable end effectors, such as fruit picking and putting the fruit in a basket below the uav and also tasks like dipping a brush tip in a liquid container hanging below the uav and delivering the liquid to a target for painting, or agricultural chemical delivery. And similar for pollen depositing or collecting dust and spider webs, which collectively we will refer to as an end effector configured to manipulate target objects.

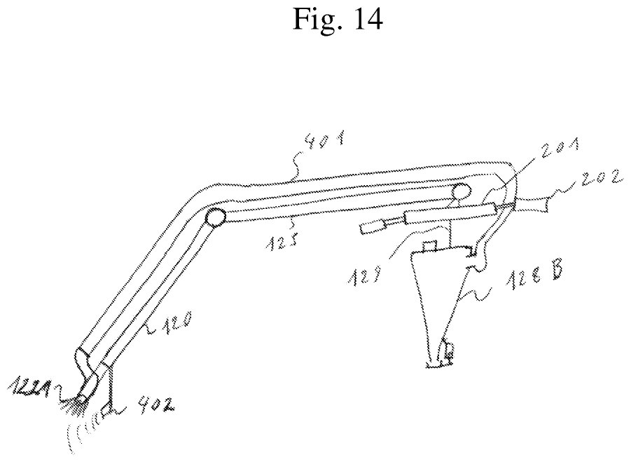

In one embodiment, as exemplified by FIG. 14, a UAV may be equipped with a robotic arm for manipulating a vacuum cleaning end effector (122M). This end effector could be connected via an air suction hose (401) to a cyclical dust separation collection bin (128B) suspended below the UAV's body by a rope. The end effector may further include multiple sensors, such as sonar sensors, to distinguish between a solid surface and spider webs, commonly found in indoor environments such as warehouses, factories, and food processing facilities. To prevent excessive suction and adhesion to surfaces, the end effector could incorporate a structure consisting of hairs surrounding the suction nozzle. The suction air hose may be guided along the robotic arm or integrated within the arm itself. Additionally, the UAV may include a sensor, such as an infrared sensor or a load cell, to monitor the dust level in the collection bin. Upon detecting a full bin, the UAV could autonomously navigate to a designated deposit site and empty the bin via a dust valve, likely located at the bin's bottom. This dust valve may be controlled by a servo motor that opens the valve upon command from the UAV's control system, allowing the dust to be deposited. After emptying, the servo motor would close the dust valve, and the UAV could resume its cleaning task. In particular this embodiment may be described as a UAV comprising a robotic arm. This robotic arm could be equipped with a vacuum cleaning end effector. The end effector may include a suction nozzle and a plurality of sensors that could be configured to distinguish between different surface types. An air suction hose may connect the end effector to a cyclical dust separation collection bin. A suspension mechanism may be configured to suspend the collection bin below the body of the UAV. Additionally, a sensor may be configured to monitor a dust level in the collection bin. In response to the sensor detecting the dust level exceeding a threshold, the UAV could be configured to autonomously navigate to a deposit site and empty the collection bin via a dust valve. The dust valve may be configured to open and close, and a servo motor may be configured to actuate the dust valve. The robotic arm may consist of one or more linkages, as possibly explained earlier. Some embodiments may direct the air exhaust from the suction motor, possibly integrated in the cyclical dust separation collection bin, to point downwards, thereby creating a upwards force on the collection bin, and making it lighter.

Some embodiments of the UAV may incorporate a dynamic balancing mechanism to enhance stability during manipulation tasks. For example, when the end-effector grasps an object, the combined center of gravity (CG) of the UAV and the object could shift away from the UAV's geometric center. To counteract this potential displacement, a secondary articulated arm may be employed. This secondary arm could be equipped with a distal weight and may be positioned opposite the primary manipulating arm. The secondary arm may comprise one or more linkages, each contributing to the overall counterbalancing effect. In one embodiment, the servos (e.g., 104 and 105), the structure that holds them in place, and the linkages that they articulate can be duplicated in a mirrored fashion on the opposing side of the UAV body (e.g., plate 102). Furthermore, the servos responsible for raising and lowering the arm linkages may be equipped with pressure sensors or stress sensors, or such sensors may be integrated into their respective cables. The stresses or pressures experienced by the corresponding sensors on both arms should be kept equal by the controller, likely with the help of a PID control loop, indicating balanced counteracting forces for optimal stability. The controller may use these sensory inputs to facilitate precise balancing by monitoring the forces exerted by the servos during manipulation tasks. By adjusting the angular disposition of this secondary arm, including the individual angles of its linkages, and the radial distance of the weight from the UAV's central axis, a counterbalancing moment may be generated. This moment could effectively reposition the combined CG, ensuring that it remains substantially aligned with the UAV's geometric center. This secondary arm may have a similar kinematic structure to the primary arm, allowing for coordinated control and a wider range of motion for precise balancing. The counterweight on the secondary arm could be adjustable, allowing for fine-tuning of the balance depending on the specific payload being manipulated by the end-effector and the position of said end-effector relative to the UAV's center.

1. A UAV comprising a robotic arm having an upper arm portion and a lower arm portion, wherein said upper arm portion and said lower arm portion are configured to articulate relative to each other in a vertical plane, and wherein said articulation is remotely actuated.

2. The UAV of claim 1, wherein said articulation is actuated by a cable-driven system comprising an antagonistic actuation mechanism comprising a member selected from the group consisting of: a spring, a rubber band, a flexible material, a servo, and a magnet, potentially located remotely, and controlled via said cable-driven system.

3. The UAV of claim 2, further comprising an actuator configured to actuate angular positioning of said upper arm portion in a vertical plane relative to the UAV body.

4. The UAV of claim 1, wherein said lower arm portion has an end effector configured to kill target insects.

5. The UAV of claim 4, wherein said end effector kills target insects by means of electrocution.

6. The UAV of claim 1, further comprising a control interface configured to allow a human operator to remotely control said articulation, wherein an input action on said control interface effects corresponding movement of said articulation.

7. The UAV of claim 1, further comprising an actuator configured to actuate angular positioning of said upper arm portion in a horizontal plane relative to the UAV body.

8. The UAV of claim 1, wherein said robotic arm further comprises an end effector configured to be able to pick up and deliver objects or liquids.

9. The UAV of claim 1, further comprising:
a camera configured to detect target objects; and
a control system configured to position said end effector in proximity to a detected target object to enable manipulation of said target object.

10. The UAV of claim 1, wherein at least one of said upper arm portion and said lower arm portion comprises carbon fiber.

11. The UAV of claim 1, comprising an end effector and at least one propeller, wherein said upper arm portion is positioned predominantly in a horizontal plane relative to said UAV body such that said lower arm portion and said end effector are positioned outside of a propeller wake generated by said at least one propeller, when manipulating with said end effector.

12. The UAV of claim 1, wherein at least one of said upper arm portion and said lower arm portion is made from a material selected from the group consisting of: foam board, foamed plastic, polystyrene, 3D-printed expanded filament, expanded polypropylene (EPP), expanded polyethylene (EPE), polyurethane foam, balsa wood, cork, and 3D-printed lightweight structures.

13. The UAV of claim 1, wherein said robotic arm comprises an upper arm linkage and a lower arm linkage connected by a hinge, and wherein said upper arm portion and said lower arm portion are respectively said upper arm linkage and said lower arm linkage, and wherein said hinge facilitates articulation of said upper arm linkage and said lower arm linkage in a vertical plane.

14. The UAV of claim 1, wherein said end effector comprises a light source that is capable of changing color, and wherein said light source is configured for use in at least one of visual storytelling, entertainment purposes, and aerial gestures for communication with a person or audience.

15. A system for autonomous operation of a UAV, the system comprising:
a UAV comprising:
a control unit; and
a robotic arm comprising at least one movable linkage; and
a camera configured to detect target objects; and
an end effector that is part of an end effector mechanism, said end effector being attached to said robotic arm and configured to manipulate target objects
a station configured to:
receive said UAV; and
swap a battery of said UAV with a charged battery or recharge a battery of said UAV; and
wherein a component of said UAV, of said robotic arm, or of said end effector mechanism is coupled to said UAV body with a mechanism that isolates said component from rotational movement of said UAV body about at least one of a roll axis or a pitch axis, wherein said component is a high voltage module, a receiver, a battery, an actuator, a container, or a basket, and wherein said container is configured to contain a liquid, and said basket is configured to contain fruit or nuts or dust.

16. The system of claim 15, wherein said robotic arm is a robotic arm according to claim 1 of the original patent application.

17. The system of claim 15, wherein said mechanism comprises a rope.

18. The system of claim 15, wherein said UAV is further configured to:
hold a liquid in a reservoir; and
propel the liquid through a tube to the nozzle of said end effector via a pump configured to draw the liquid from said reservoir or create pressure that directly or indirectly propels said liquid; and
optionally comprises a valve to control the flow of liquid to the nozzle, wherein said valve is positioned proximate to the nozzle and is remotely actuated via a cable, and wherein said valve is a pinch valve or a needle valve.

19. The system of claim 15, wherein the control unit is further configured to execute a location prioritization algorithm that selects locations for targeting insects based on a frequency of previous encounters with target insects at those locations.

20. The system of claim 19, wherein the control unit is further configured to:
store information about previous encounters with target insects at locations within an operational area;
estimate an insect emergence rate for each location based on the stored information; and
select locations for targeting insects based on the estimated insect emergence rates.
